(19) United States
(12) Patent Application Publication
(10) Pub. No.: US 2013/0139531 A1
(43) Pub. Date: Jun. 6, 2013

(54) REFRIGERATION SYSTEM HAVING A CONTINUOUSLY VARIABLE TRANSMISSION

(71) Applicant: FALLBROOK INTELLECTUAL PROPERTY COMP, San Diego, CA (US)

(72) Inventors: Brad P. Pohl, Leander, TX (US); Robert Smithson, Cedar Park, TX (US); Scott T. McBroom, Round Rock, TX (US); Terry R. Nielsen, Austin, TX (US); Mark A. Frank, Austin, TX (US); Blake C. Gettig, Seguin, TX (US); Joseph F. Paterson, Johnson City, TX (US)

(73) Assignee: FALLBROOK INTELLECTUAL PROPERTY COMPANY LLC, San Diego, CA (US)

(21) Appl. No.: 13/633,474

(22) Filed: Oct. 2, 2012

Related U.S. Application Data
(60) Provisional application No. 61/542,708, filed on Oct. 3, 2011.

(51) Int. Cl. F25B 49/02; F15B 13/04; F16H 15/50

(52) U.S. Cl. CPC F25B 49/022; F16H 15/503; F15B 13/0402
USPC 62/115; 475/189; 62/505; 62/513; 60/463; 29/890.035

(57) ABSTRACT

Inventive embodiments are directed to components, subassemblies, systems, and/or methods for a refrigeration system having a compressor operably coupled to continuously variable accessory drive (CVAD). In one embodiment, the refrigerant is adapted to cool the CVAD. In another embodiment, the refrigerant is configured to actuate a change in operating condition of the CVAD. A change in operating condition of the CVAD can be based at least in part on the thermodynamic state, such as pressure or temperature, of the refrigerant. In one embodiment, a skew-based control system is adapted to facilitate a change in the ratio of a CVAD. In another embodiment, a skew-based control system includes a skew actuator coupled to a carrier member. In some embodiments, the skew actuator is configured to rotate a carrier member of a CVT. Among other things, shift control interfaces for a CVT are disclosed.

### CROSS REFERENCE TO RELATED APPLICATIONS

This application claims the benefit of U.S. Provisional Patent Application No. 61/542,708 filed on Oct. 3, 2011, which is hereby incorporated by reference in its entirety.

### BACKGROUND OF THE INVENTION

1. Field of the Invention

This disclosure relates generally to mechanical and/or electro-mechanical power modulation devices and methods, and more particularly to continuously and/or infinitely variable, planetary power modulating devices and methods for modulating power flow in a power train or drive, such as power flow from a prime mover to one or more auxiliary or driven devices.

2. Description of the Related Art

In certain systems, a single power source drives multiple devices. The power source typically has a narrow operating speed range at which the performance of the power source is optimum. It is preferred to operate the power source within its performance optimizing operating speed range. A driven device typically also has a narrow operating speed range at which the performance of the driven device is optimum. It is also preferred to operate the driven device within its performance optimizing operating speed range. A coupling is usually employed to transfer power from the power source to the driven device. Where a direct, non-modulating coupling couples the power source to the driven device, the driven device operates at a speed proportional to that of the power source. However, it is often the case that the optimum operating speed of the driven device is not directly proportional to the optimum operating speed of the power source. Therefore, it is preferred to incorporate into the system a coupling adapted to modulate between the speed of the power source and the speed of the driven device.

Couplings between the power source and the driven devices can be selected such that the input speed from the power source is reduced or increased at the output of a given coupling. However, in frequently implemented systems, typical known power train configurations and/or coupling arrangements allow at best for a constant ratio between the input speed from the power source and the speed of power transfer to the driven device. One such system is the so-called front end accessory drive (FEAD) system employed in many automotive applications. In a typical FEAD system, the prime mover (usually an internal combustion engine) provides the power to run one or more accessories, such as a cooling fan, water pump, oil pump, power steering pump, alternator, etc. During operation of the automobile, the accessories are forced to operate at speeds that have a fixed relationship to the speed of the prime mover. Hence, for example, as the speed of the engine increases from 800 revolutions per minute (rpm) at idle to 2,500 rpm at cruising speed, the speed of each accessory driven by the engine increases proportionally to the increase in engine speed, such that some accessories may be operating at varying speeds ranging between 1,600 rpm to 8,000 rpm. The result of such system configuration is that often any given accessory does not operate within its maximum efficiency speed range. Consequently, inefficiencies arise from wasted energy during operation and oversizing of the accessories to handle the speed and/or torque ranges.

Thus, there exists a continuing need for devices and methods to modulate power transfer between a prime mover and driven devices. In some systems, it would be beneficial to regulate the speed and/or torque transfer from an electric motor and/or internal combustion engine to one or more driven devices that operate at varying efficiency optimizing speeds. In some current automotive applications, there is a need for a power modulating device to govern the front end accessory drive within existing packaging limits. The inventive embodiments of power modulating devices and/or drivetrains described below address one or more of these needs.

### SUMMARY OF THE INVENTION

The systems and methods herein described have several features, no single one of which is solely responsible for its desirable attributes. Without limiting the scope as expressed by the claims that follow, its more prominent features will now be discussed briefly. After considering this discussion, and particularly after reading the section entitled “Detailed Description of Certain Embodiments” one will understand how the features of the system and methods provide several advantages over traditional systems and methods.

One aspect of the disclosure relates to a refrigeration system having an evaporator, an expansion valve, and a condenser. In one embodiment, the refrigeration system has a compressor in fluid communication with the evaporator, the expansion valve, and the condenser. A continuously variable transmission (CVT) is operably coupled to the compressor. The CVT is adapted to provide a power input to the compressor. In one embodiment, a CVT cooling system is operably coupled to internal components of the CVT. The CVT cooling system is in fluid communication with the compressor, the evaporator, the expansion valve, and the condenser.

Another aspect of the disclosure concerns a refrigeration system having an evaporator, an expansion valve, a compressor, and a condenser, each coupled hydraulically with a refrigerant. In one embodiment, the refrigeration system has a continuously variable transmission (CVT) coupled to the compressor. The CVT is configured to provide an input power to the compressor. The refrigeration system has a cooling system operably coupled to the CVT. The cooling system is in thermal communication with the refrigerant.

Yet another aspect of the disclosure concerns an actuator for a continuously variable transmission (CVT) having a plurality of spherical traction planets. Each traction planet is supported by first and second carrier members. The first carrier member is configured to rotate with respect to the second carrier member to facilitate a change in operating condition of the CVT. In one embodiment, the actuator has a hydraulic piston coupled to the CVT. The actuator has a hydraulic control valve in fluid communication with the hydraulic piston. A spool actuator is coupled to the hydraulic control valve. The spool actuator is configured to adjust the hydraulic control valve based at least in part on a operating condition of the CVT. The hydraulic piston, the hydraulic control valve, and the spool actuator hydraulically couple to a working fluid of a refrigeration system.

One aspect of the disclosure concerns a method of improving the performance of a refrigeration system having a compressor, a condenser, an evaporator and refrigerant. In one embodiment, the method includes the step of providing a CVT adapted to vary the speed of the compressor and having a transmission fluid system. The method has the step of varying the operating speed of the compressor by varying the transmission ratio of the CVT. In one embodiment, the method includes transferring heat from the transmission fluid system to the refrigerant.

Another aspect of the disclosure relates to a method of manufacturing a refrigeration system. In one embodiment, the method has the step of providing a first heat exchanger. The first heat exchanger is exposed to an environment at a first temperature. The method includes coupling the first heat exchanger to an expansion valve. The method has the step of providing a second heat exchanger. The second heat exchanger is exposed to an environment at a second temperature. The method includes coupling the second heat exchanger to the expansion valve and providing a compressor. In one embodiment, the method has the step of configuring the compressor to pump a working fluid between the first and second heat exchangers and the expansion valve. The method includes coupling a continuously variable transmission (CVT) to the compressor. The CVT is configured to change operating condition based at least in part to a change in a state of the working fluid.

Another aspect of the disclosure concerns a method of manufacturing a refrigeration system. In one embodiment, the method includes the step of providing a first heat exchanger, the first heat exchanger exposed to an environment at a first temperature. The method has the step of coupling the first heat exchanger to an expansion valve. The method includes providing a second heat exchanger. The second heat exchanger is exposed to an environment at a second temperature. The method has the step of coupling the second heat exchanger to the expansion valve and providing a compressor. In one embodiment, the method includes the step of configuring the compressor to pump a working fluid between the first and second heat exchangers and the expansion valve. The method has the step of coupling a continuously variable transmission (CVT) to the compressor. The method includes providing a third heat exchanger operably coupled to internal components of the CVT. In one embodiment, the method includes hydraulically coupling the third heat exchanger to the working fluid, whereby the working fluid is exposed to a waste heat from the internal components of the CVT.

### BRIEF DESCRIPTION OF THE FIGURES

FIG. 1 is a schematic illustration of a refrigeration system having a continuously variable transmission (CVT) operably coupled to a compressor.

FIG. 2 is a Temperature-Entropy diagram depicting the refrigeration cycle of FIG. 1.

FIG. 3 is schematic illustration of a compressor coupled to a CVT that can be used in the refrigeration system of FIG. 1.

FIG. 4 is another schematic illustration of a compressor coupled to a CVT that can be used in the refrigeration system of FIG. 1.

FIG. 5 is yet another schematic illustration of a compressor coupled to a CVT that can be used in the refrigeration system of FIG. 1.

FIG. 6 is a cross-sectional view of a compressor coupled to a CVT that can be used in the refrigeration system of FIG. 1.

FIG. 7 is a schematic diagram of a refrigeration system having a CVT coupled to a compressor.

FIG. 8 is a schematic diagram of a refrigeration system having a CVT coupled to a compressor.

FIG. 9 is a plan view of a compressor housing configured to be in fluid communication with a CVT.

### DETAILED DESCRIPTION OF CERTAIN EMBODIMENTS

The preferred embodiments will be described now with reference to the accompanying figures, wherein like numerals refer to like elements throughout. The terminology used in the descriptions below is not to be interpreted in any limited or restrictive manner simply because it is used in conjunction with detailed descriptions of certain specific embodiments of the disclosure. Furthermore, embodiments of the disclosure can include several novel features, no single one of which is solely responsible for its desirable attributes or which is essential to practicing the embodiments described. Certain CVT embodiments described here are generally related to the type disclosed in U.S. Pat. Nos. 6,241,636; 6,419,608; 6,689,012; 7,011,600; 7,166,052; U.S. patent application Ser. Nos. 11/243,484; 11/543,311; 12/198,402; 12/251,325 and Patent Cooperation Treaty patent applications PCT/US2007/023315, PCT/IB2006/054911, PCT/US2008/068929, and PCT/US2007/023315, PCT/US2008/074496. The entire disclosure of each of these patents and patent applications is hereby incorporated herein by reference.

As used here, the terms “operationally connected,” “operationally coupled”, “operationally linked”, “operably connected”, “operably coupled”, “operably linked,” and like terms, refer to a relationship (mechanical, linkage, coupling, etc.) between elements whereby operation of one element results in a corresponding, following, or simultaneous operation or actuation of a second element. It is noted that in using said terms to describe inventive embodiments, specific structures or mechanisms that link or couple the elements are typically described. However, unless otherwise specifically stated, when one of said terms is used, the term indicates that the actual linkage or coupling may take a variety of forms, which in certain instances will be readily apparent to a person of ordinary skill in the relevant technology. For description purposes, the term “axial” as used here refers to a direction or position along an axis that is parallel to a main or longitudinal axis of a driven device, a transmission or variator. The term “radial” is used here to indicate a direction or position that is perpendicular relative to a longitudinal axis of a transmission or variator.

It should be noted that reference herein to “traction” does not exclude applications where the dominant or exclusive mode of power transfer is through “friction.” Without attempting to establish a categorical difference between traction and friction drives here, generally these may be understood as different regimes of power transfer. Traction drives usually involve the transfer of power between two elements by shear forces in a thin fluid layer trapped between the elements. The fluids used in these applications usually exhibit traction coefficients greater than conventional mineral oils. The traction coefficient (μ) represents the maximum available traction forces which would be available at the interfaces of the contacting components and is a measure of the maximum available drive torque. Typically, friction drives generally relate to transferring power between two elements by frictional forces between the elements. For the purposes of this disclosure, it should be understood that the CVTs described here may operate in both tractive and frictional applications. For example, in the embodiment where a CVT is used for a bicycle application, the CVT can operate at times as a friction drive and at other times as a traction drive, depending on the torque and speed conditions present during operation.

Embodiments disclosed here are related to the control of a variator and/or a CVT using generally spherical planets each having a tiltable axis of rotation that can be adjusted to achieve a desired ratio of input speed to output speed during operation. In some embodiments, adjustment of said axis of rotation involves angular displacement of the planet axis in a first plane in order to achieve an angular adjustment of the planet axis in a second plane, wherein the second plane is substantially perpendicular to the first plane. The angular displacement in the first plane is referred to here as “skew”, “skew angle”, and/or “skew condition”. For discussion purposes, the first plane is generally parallel to a longitudinal axis of the variator and/or the CVT. The second plane can be generally perpendicular to the longitudinal axis. In one embodiment, a control system coordinates the use of a skew angle to generate forces between certain contacting components in the variator that will tilt the planet axis of rotation substantially in the second plane. The tilting of the planet axis of rotation adjusts the speed ratio of the variator. The aforementioned skew angle, or skew condition, can be applied in a plane substantially perpendicular to the plane of the page of FIG. 4, for example. Embodiments of transmissions employing certain inventive skew control systems for attaining a desired speed ratio of a variator will be discussed.

Other embodiments disclosed here are related to continuously variable transmissions having spherical planets such as those generally described in U.S. Pat. No. 7,125,359 to Milner, U.S. Pat. No. 4,744,261 to Jacobson, U.S. Pat. No. 5,236,403 to Schievelbusch, or U.S. Pat. No. 2,469,653 to Kopp. Some embodiments disclosed here are related to continuously variable transmissions having belts or chains, see for example U.S. Pat. No. 7,396,311 to Gates. Yet other embodiments disclosed here are related to transmissions having toroidal discs for transmitting power. See for example U.S. Pat. No. 7,530,916 to Greenwood and U.S. Pat. No. 6,443,870 to Yoshikawa et al. The entire disclosure of each of these patents and patent applications is hereby incorporated herein by reference.

Embodiments of the torque/speed regulating devices disclosed here can be used to control the speed of the power delivered to the accessories powered by a prime mover. For example, in some embodiments, the speed regulators disclosed here can be used to control the speed of automotive accessories, such as an air-conditioning (AC) compressor, driven by a pulley attached to the crankshaft of an automotive engine. Usually, refrigeration systems having a compressor must perform suitably both when the engine idles at low speed and when the engine runs at high speed. Often AC compressors operate optimally at one speed and suffer from reduced efficiency at other speeds. Additionally, the AC compressor design is compromised by the need to perform over a large speed range rather than an optimized narrow speed range. In many cases when the engine runs at a speed other than low speed, the AC compressor consumes excess power and, thereby, reduces vehicle fuel economy. The power drain caused by the AC compressor also reduces the engine's ability to power the vehicle, necessitating a larger engine in some cases.

The torque/speed regulator systems disclosed here can facilitate reducing the size and weight of the accessories as well as the prime mover, thereby reducing the weight of the vehicle and thus increasing fuel economy. Further, in some cases, the option to use smaller accessories and a smaller prime mover lowers the cost of these components and of the vehicle. Smaller accessories and a smaller prime mover can also provide flexibility in packaging and allow the size of the system to be reduced. Embodiments of the torque/speed regulators described here can also increase fuel economy by allowing the accessories to operate at their most efficient speed across the prime mover operating range. Finally, the torque/speed regulators increase fuel economy by preventing the accessories from consuming excess power at any speed other than low.

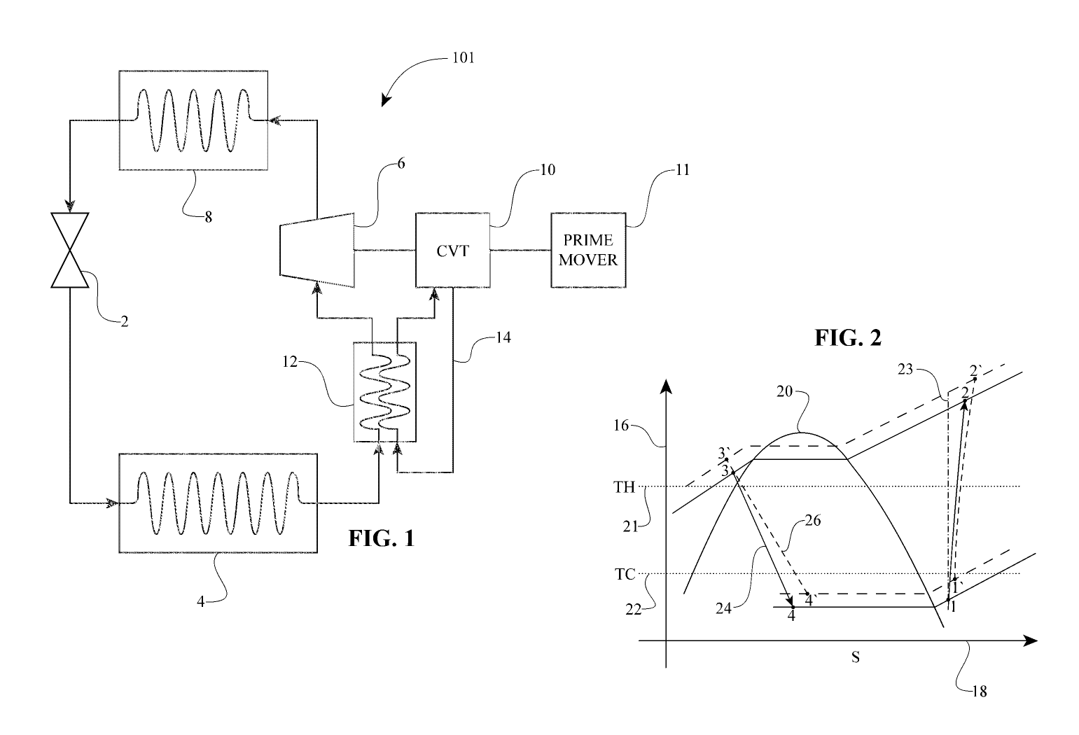

Referring now to FIGS. 1 and 2, in one embodiment a refrigeration system 1 can include an expansion valve 2 in fluid communication with a first heat exchanger or an evaporator 4. The refrigeration system 1 is provided with a compressor 6. The compressor 6 is in fluid communication with a second heat exchanger or a condenser 8. In one embodiment, the compressor 6 is coupled to a continuously variable transmission (CVT) 10. The CVT 10 can be adapted to modulate speed and/or torque from a prime mover 11 to the compressor 6. In some embodiments, the CVT 10 is in fluid communication with a third heat exchanger 12. The CVT 10 can be provided with a lubricant system 14. The lubricant system 14 can be operably coupled to the third heat exchanger 12. During operation of the refrigeration system 1, waste heat generated by the CVT 10 can be discharged to a working fluid, such as a refrigerant, of the refrigeration system 1 through the third heat exchanger 12. In some embodiments, the lubricant system 14 can provide cooling to components of the compressor 6.

Operation of the refrigeration system 1 can be described using a temperature-entropy (T-s) diagram, such as the one depicted in FIG. 2. The vertical axis 16 of the diagram depicts the temperature of the working fluid. The horizontal axis 18 depicts the entropy of the working fluid. A curve 20 is the well-known vapor dome curve, which is representative for a given working fluid. Construction lines 21, 22 represent lines of constant temperature. For descriptive purposes, the constant temperature lines 21, 22 correspond to the temperature of two spaces between which the refrigeration cycle is operating, for example the temperature of an interior of a vehicle and the ambient exterior temperature. A construction line of constant entropy 23 is depicted on the diagram of FIG. 2 for reference.

A representative cycle 24 is shown on the T-s diagram in solid lines to depict an idealized refrigeration system. A representative cycle 26 is depicted on the T-s diagram in dashed lines to illustrate operation of the refrigeration system 1, for example. It should be noted that waste heat from the CVT is rejected to the refrigerant. As shown in the diagram, the impact of adding heat to the system could increase the exit temperature of the evaporator 4 (state 1, depicted on the T-s diagram as “1” for the idealized refrigeration cycle and “1′” for the refrigeration system 1). Waste heat rejection from the CVT 10 will influence the high side temperature (state 2). As the refrigeration system 1 is operated, a new thermodynamic balance will be achieved that ultimately raises the pressures and temperatures in the system as compared to an idealized refrigeration system. If the low side evaporator temperature is increased relative to the fixed cold side temperature (for example “TC” represented by construction line 22), then the amount of heat removed from the cold side will fall, thereby influencing the coefficient of performance of the refrigeration system.

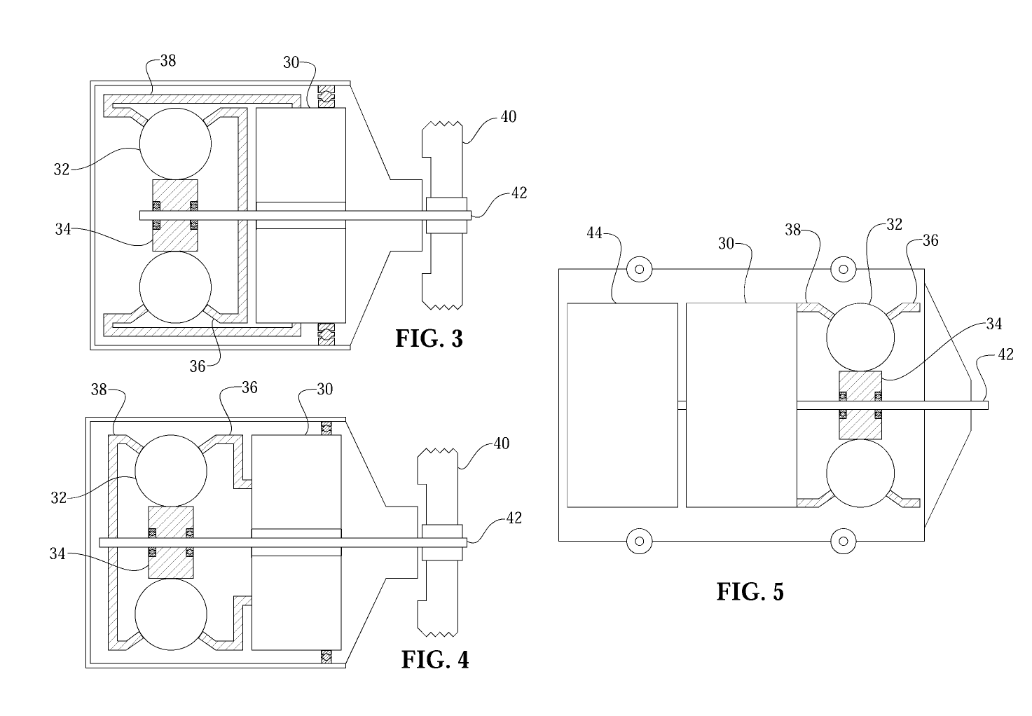

Turning now to FIGS. 3-5, in one embodiment a scroll compressor 30 can be coupled to a CVT having a plurality of spherical traction planets 32 in contact with an idler 34, and first and second traction rings 36 and 38, respectively. A power can be transmitted to the CVT, for example, through a pulley 40 coupled to a drive shaft 42. In one embodiment, such as the embodiment depicted in FIG. 3, the drive shaft 42 delivers power to the first traction ring 36. The torque and/or speed can be modulated by manipulation of the traction planets 32 and transferred to the scroll compressor 30 by operably coupling the second traction ring 38 to the scroll compressor 30. In some embodiments, such as the embodiment depicted in FIG. 4, the drive shaft 42 can be operably coupled to the second traction ring 38. A modulated power can be transmitted to the scroll compressor 30 through the first traction ring 36. In other embodiments, such as the embodiment depicted in FIG. 5, the scroll compressor 30 can be operably coupled to a pressure chamber 44. It should be noted that the actual mechanical implementation of the coupling of the scroll compressor 30 to a CVT can be configured to accommodate a variety of continuously variable transmissions.

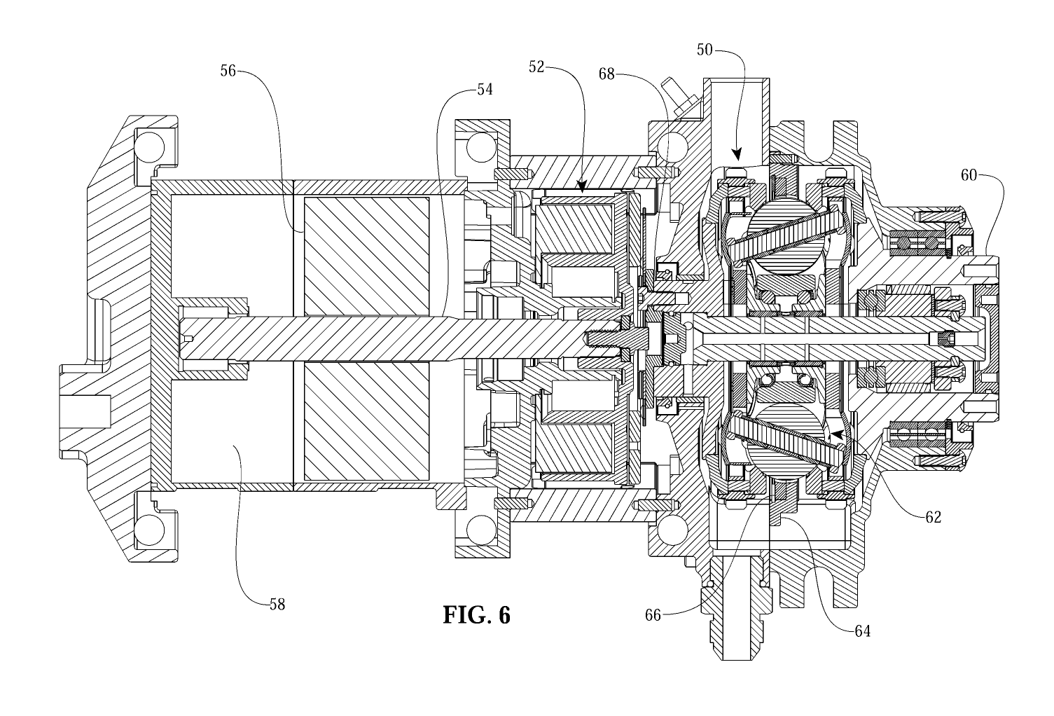

Referring now FIG. 6, in one embodiment a CVT 50 can be operably coupled to a magnetic clutch 52. The magnetic clutch 52 can be operably coupled to a compressor shaft 54. The compressor shaft 54 can be adapted to couple to a scroll 56. In one embodiment, a resonance chamber 58 can be operably coupled to the scroll 56. In one embodiment, the CVT 50 can be similar to embodiments of continuously variable transmissions disclosed in U.S. patent application Ser. No. 12/251,325. A power can be transmitted to the CVT 50 from, for example, an engine (not shown) through a power input shaft 60. Torque and/or speed can be modulated through the CVT 50 by manipulation of a plurality of spherical traction planet assemblies 62. In one embodiment, the traction planet assemblies 62 can be adjusted by a relative rotation of a first carrier member 64 with respect to a second carrier member 66. The relative rotation of the first carrier member 64 with respect to the second carrier member 66 can, in some embodiments, adjust a skew condition of the traction planet assemblies 62 to thereby facilitate an adjustment in the torque and/or speed ratio of the CVT 50. Modulated power can be transmitted from the CVT 50 by an output power shaft 68. The output power shaft 68 can be operably coupled to the magnetic clutch 52.

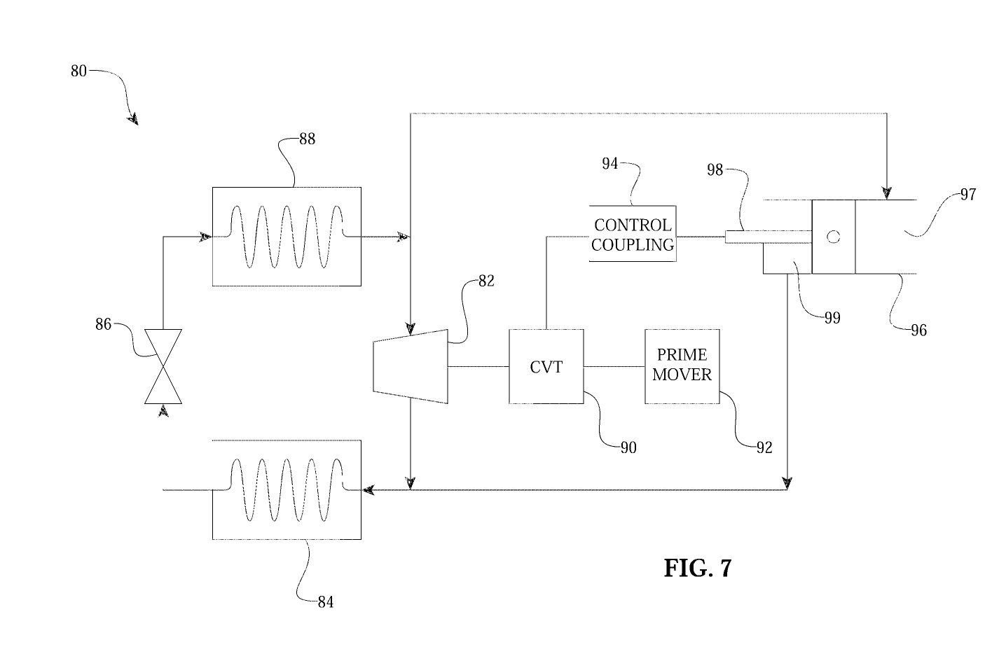

Turning now to FIG. 7, in one embodiment, a refrigeration system 80 can include a compressor 82 adapted to pump a working fluid, such as a refrigerant, through a condenser 84, an expansion valve 86, and an evaporator 88. The compressor 82 can be operably coupled to a CVT 90. The CVT 90 can be operably coupled to, for example, a prime mover 92 of a vehicle. In one embodiment, the CVT 90 is operably coupled to a control coupling 94. The control coupling 94 can be a mechanical linkage or electro-mechanical linkage configured to adjust certain components of the CVT 90 to thereby facilitate a change in operating condition of the CVT 90. In one embodiment, the control coupling 94 is a clevis (not shown) coupled to a first carrier member, such as the first carrier member 64 depicted in FIG. 6. In some embodiments, the refrigeration system 80 can be provided with a double acting piston valve 96. The valve 96 has a piston 98. The piston 98 can be operably coupled to the control coupling 94. The valve 96 can have a first chamber 97 located on one side of the piston 98. The first chamber 97 can be adapted to be exposed to a low pressure of the refrigeration system 80. For example, the first chamber 97 can have substantially the same pressure as the operating pressure of the refrigerant at the exit of the evaporator 88. The valve 96 can have a second chamber 99 located on another side of the piston 98. The second chamber 99 can be adapted to be exposed to a high pressure of the refrigeration system 80. For example, the second chamber 99 can have substantially the same pressure as the operating pressure of the refrigerant at the entrance of the condenser 84. In other embodiments, the piston 98 can be coupled to a spring (not shown) to return the piston 98 to a neutral position or to provide a pre-set position of the piston 98. In yet other embodiments, the piston 98 can be operably coupled to a negative pressure chamber (not shown), in order to return the piston 98 to a neutral position or to provide a pre-set position of the piston 98.

During operation of the refrigeration system 80, a differential pressure generated between the first chamber 97 and the second chamber 99 can generate a displacement of the piston 98 in the valve 96. Displacement of the piston 98 is translated through the control coupling 94 to facilitate a change in operating condition of the CVT 90. It should be noted that the differential pressure generated between the first and second chambers 97 and 99, respectively, is generated by the thermodynamic states of the refrigerant in the refrigeration system 80.

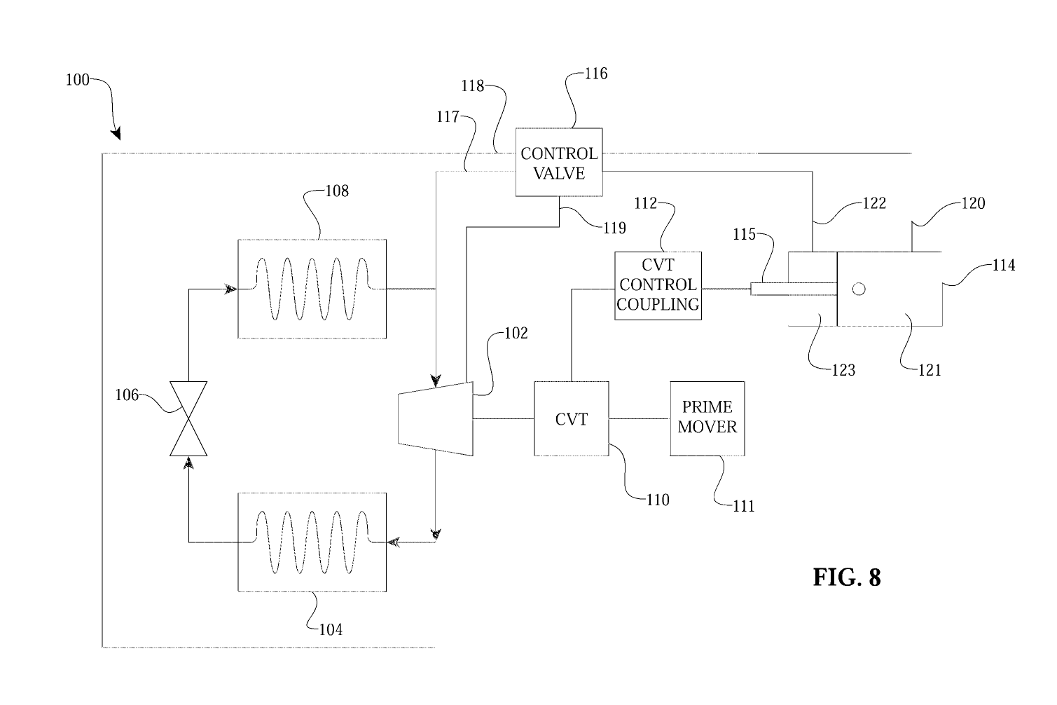

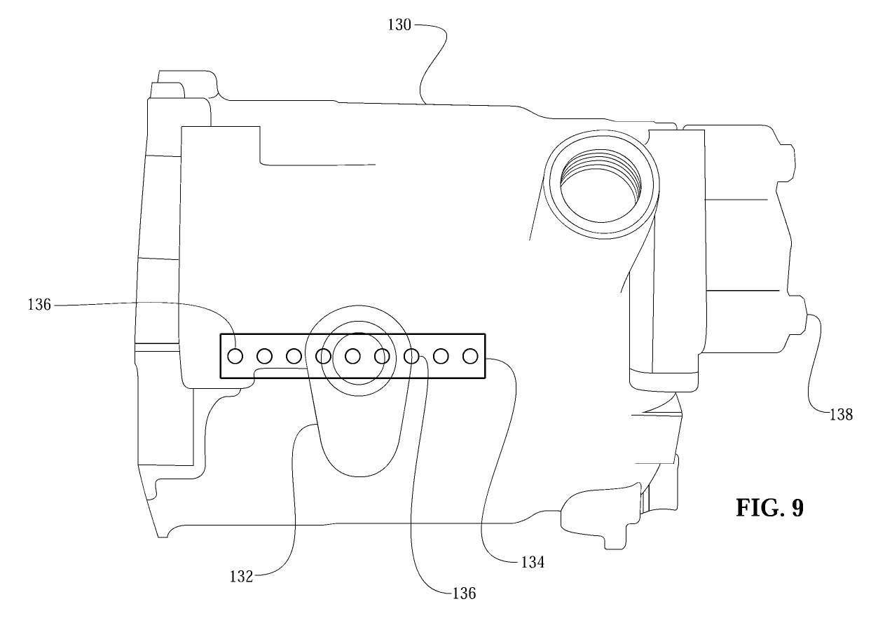

Referring now to FIG. 8, in one embodiment, a refrigeration system 100 can have a compressor 102 adapted to pump a refrigerant through a condenser 104, an expansion valve 106, and an evaporator 108. The compressor 102 can be operably coupled to a CVT 110. The CVT 110 can modulate torque and/or speed to the compressor 102 from a prime mover 111. In one embodiment, the CVT 110 is operably coupled to a CVT control coupling 112. The CVT control coupling 112 can be a mechanical linkage or electro-mechanical linkage configured to adjust certain components of the CVT 110. The refrigeration system 100 can be provided with a double acting piston valve 114 having a piston 115. The valve 114 can be coupled to the CVT control coupling 112. In one embodiment, the refrigeration system 100 is provided with a control valve 116. The control valve 116 is in fluid communication with the valve 114. In some embodiments, the control valve 116 is configured to sense a pressure 117 on the inlet side of the compressor 102 and a pressure 118 on the outlet side of the compressor 102. In other words, the control valve 116 can sense a differential pressure of the refrigeration system 100. In some embodiments, the control valve 116 can be configured to receive a signal 119 from the compressor 102. The control valve 116 can provide a first control pressure 120 to a first chamber 121 of the valve 114. The control valve 116 can provide a second control pressure 122 to a second chamber 123 of the valve 114. In some embodiments, the control valve 116 can further be coupled to a hydraulic accumulator (not shown). The accumulator can be used to manage potential high pressure discharge from the compressor 102 and prevent slipping of the CVT 110. In other embodiments, the control valve 114 can be coupled to axial force generating components of the CVT 110 (not shown) in order to provide load based axial force during operation.

During operation of the refrigeration system 100, a differential pressure generated across the compressor 102 can be communicated to the valve 114 through the control valve 116. A differential pressure generated between the first and second chambers 121 and 123, respectively, can generate a displacement of the piston 115. The displacement of the piston 115 can be translated by the CVT control coupling 112 to the CVT 110 to thereby facilitate a change in operating condition of the CVT 110. It should be noted that the control valve 116, in some embodiments, enables the magnitude of the pressure differential between the first and second chambers 121 and 123 to differ from the magnitude of the pressure differential across the compressor 102.

Turning now to FIG. 9, in one embodiment a substantially enclosed housing 130 can be used to support, for example a scroll compressor for a refrigeration system, among other things. The housing 130 is provided with a suction port 132 and a discharge port 138. The suction port 132 and the discharge port 138 typically direct a refrigerant, such as R134A, into and out of a compressor. The housing 130 can be equipped with an adapter plate 134 having a plurality of holes or channels 136. The adapter plate 134 creates a connection to the suction port 132 that allows for the spread of refrigerant flow across a compressor scroll and across a CVT. The channels 136 can converge at one end of the adapter plate 134. For example the convergence of the channels 136 can be in proximity to the suction port 132. The channels 136 can diverge at the other end of the adapter plate 134. In one embodiment, the adapter plate 134 is located on the interior of the housing 130. The flow of refrigerant provides cooling to the compressor components and the CVT components within the housing 130.

It should be noted that the description above has provided dimensions for certain components or subassemblies. The mentioned dimensions, or ranges of dimensions, are provided in order to comply as best as possible with certain legal requirements, such as best mode. However, the scope of the embodiments described herein are to be determined solely by the language of the claims, and consequently, none of the mentioned dimensions is to be considered limiting on the inventive embodiments, except in so far as anyone claim makes a specified dimension, or range of thereof, a feature of the claim.

The foregoing description details certain embodiments of the disclosure. It will be appreciated, however, that no matter how detailed the foregoing appears in text, the disclosure can be practiced in many ways. As is also stated above, it should be noted that the use of particular terminology when describing certain features or aspects of the disclosure should not be taken to imply that the terminology is being re-defined herein to be restricted to including any specific characteristics of the features or aspects of the disclosure with which that terminology is associated.

What we claim is:

1. A refrigeration system having an evaporator, an expansion valve, and a condenser, the refrigeration system comprising:
a compressor in fluid communication with the evaporator, the expansion valve, and the condenser;
a continuously variable transmission (CVT) operably coupled to the compressor, the CVT adapted to provide a power input to the compressor;
a CVT cooling system operably coupled to internal components of the CVT, the CVT cooling system in fluid communication with the compressor, the evaporator, the expansion valve, and the condenser.

2. The refrigeration system of claim 1, further comprising a working fluid hydraulically coupled to the evaporator, the expansion valve, the condenser, and the compressor, wherein the working fluid is operably coupled to the CVT cooling system.

3. The refrigeration system of claim 1, wherein the working fluid receives heat from the CVT cooling system during operation of the refrigeration system.

4. The refrigeration system of claim 3, wherein the CVT cooling system comprises a heat exchanger in fluid communication with the working fluid and a lubricant fluid of the CVT, the heat exchanger configured to receive the working fluid at the exit of the evaporator.

5. The refrigeration system of claim 3, wherein the CVT cooling system comprises a dual pass heat exchanger in fluid communication with the working fluid and a lubricant fluid of the CVT.

6. The refrigeration system of claim 3, further comprising an actuator coupled to the CVT, the actuator configured to facilitate a change in operating condition of the CVT, the actuator operably coupled to the working fluid

7. The refrigeration system of claim 4, wherein a change in a thermodynamic state of the working fluid facilitates a change in operating condition of the CVT.

8. A refrigeration system having an evaporator, an expansion valve, a compressor, and a condenser, each coupled hydraulically with a refrigerant, the refrigeration system comprising:
a continuously variable transmission (CVT) coupled to the compressor, the CVT configured to provide an input power to the compressor;
a cooling system operably coupled to the CVT; and
wherein the cooling system is in thermal communication with the refrigerant.

9. The refrigeration system of claim 8, wherein the CVT has a longitudinal axis, the CVT comprises:
a plurality of spherical traction planets arranged angularly about the longitudinal axis;
a first carrier member operably coupled to each traction planet, the first carrier member provided with a plurality of radially off-set guide slots;
a second carrier member operably coupled to each traction planet, the second carrier member provided with a plurality of radial guide slots; and
wherein the first carrier member can be rotated with respect to the second carrier member to thereby facilitate a change in operating condition of the CVT.

10. The refrigeration system of claim 9, further comprising an actuator operably coupled to the first carrier member, the actuator adapted to facilitate a rotation of the first carrier member with respect to the second carrier member, the actuator in fluid communication with the refrigerant.

11. The refrigeration system of claim 9, further comprising an actuator operably coupled to the second carrier member, the actuator adapted to facilitate a rotation of the second carrier member with respect to the first carrier member, the actuator in fluid communication with the refrigerant.

12. The refrigeration system of claim 11, wherein the actuator comprises a piston operably coupled to the refrigerant.

13. The refrigeration system of claim 13, wherein the piston is coupled to a spring.

14. The refrigeration system of claim 13, wherein the piston is coupled to negative pressure chamber.

15. An actuator for a continuously variable transmission (CVT) having a plurality of spherical traction planets, each supported by first and second carrier members, wherein the first carrier member is configured to rotate with respect to the second carrier member to facilitate a change in operating condition of the CVT, the actuator comprising:
a hydraulic piston coupled to the CVT;
a hydraulic control valve in fluid communication with the hydraulic piston;
a spool actuator coupled to the hydraulic control valve, the spool actuator configured to adjust the hydraulic control valve based at least in part on a operating condition of the CVT; and
wherein the hydraulic piston, the hydraulic control valve, and the spool actuator hydraulically couple to a working fluid of a refrigeration system.

16. The skew actuator of claim 15, wherein the hydraulic control valve comprises a housing and a piston, the piston configured to translate with respect to the housing based at least in part on a change in condition of the working fluid.

17. The skew actuator of claim 16, wherein the change in condition of the working fluid is a pressure.

18. The skew actuator of claim 16, wherein the change in condition of the working fluid is a temperature.

19. A method of improving the performance of a refrigeration system having a compressor, a condenser, an evaporator and refrigerant, the method comprising the steps of:
providing a CVT adapted to vary the speed of the compressor and having a transmission fluid system;
varying the operating speed of the compressor by varying the transmission ratio of the CVT; and
transferring heat from the transmission fluid system to the refrigerant.

20. The method of claim 19, further comprising the step of providing a heat exchanger in fluid communication with the transmission fluid system and the refrigerant.

21. The method of claim 20, wherein providing a heat exchanger comprises the step of providing a dual pass heat exchanger.

22. The method of claim 20, wherein providing a heat exchanger comprises the step of configuring the heat exchanger to receive refrigerant at the exit of the evaporator.

23. A method of manufacturing a refrigeration system comprising the steps of:
providing a first heat exchanger, the first heat exchanger exposed to an environment at a first temperature;
coupling the first heat exchanger to an expansion valve;
providing a second heat exchanger, the second heat exchanger exposed to an environment at a second temperature;
coupling the second heat exchanger to the expansion valve;
providing a compressor;
configuring the compressor to pump a working fluid between the first and second heat exchangers and the expansion valve;
coupling a continuously variable transmission (CVT) to the compressor, wherein the CVT is configured to change operating condition based at least in part to a change in a state of the working fluid.

24. A method of manufacturing a refrigeration system comprising the steps of:
providing a first heat exchanger, the first heat exchanger exposed to an environment at a first temperature;
coupling the first heat exchanger to an expansion valve;
providing a second heat exchanger, the second heat exchanger exposed to an environment at a second temperature;
coupling the second heat exchanger to the expansion valve;
providing a compressor;
configuring the compressor to pump a working fluid between the first and second heat exchangers and the expansion valve;
coupling a continuously variable transmission (CVT) to the compressor;
providing a third heat exchanger operably coupled to internal components of the CVT; and
hydraulically coupling the third heat exchanger to the working fluid, whereby the working fluid is exposed to a waste heat from the internal components of the CVT.
